(19) United States
(12) Patent Application Publication
(10) Pub. No.: US 2005/0068434 A1
(43) Pub. Date: Mar. 31, 2005

(54) Color solid state image pickup device

(75) Inventor: Toshinobu Hatano, Kyoto (JP)

Correspondence Address: McDERMOTT, WILL EMERY, 600 13th Street, N.W., Washington, DC, 20005-3096, US

(73) Assignee: MATSUSHITA ELECTRIC INDUSTRIAL CO., LTD.

(21) Appl. No.: 10/951,891

(22) Filed: Sep. 29, 2004

(30) Foreign Application Priority Data
Sep. 30, 2003 (JP) P2003-341670

(51) Int. Cl. H04N 5/335

(52) U.S. Cl. 348/272

(57) ABSTRACT

Provided is a color solid state image pickup device which comprises a photoelectrical conversion element array and a control unit for controlling reading-out of pixel data. The control unit has a whole-pixel-reading-out mode and vertically/horizontally-mixed-pixel-reading-out mode, by which data are simultaneously outputted from four channels of output sections. In the whole-pixel-reading-out mode, separate and parallel output of GRBG pixel data is simultaneously performed using the four channels of output sections with a group of pixels in two lines and two rows in the photoelectrical conversion element array being a first output unit. Meanwhile, in the vertically/horizontally-mixed-pixel-reading-out mode, separate and parallel output of GRBG mixed pixel data is simultaneously performed using the four channels of output sections with a group of pixels in 2n lines and 2n rows in the photoelectrical conversion element array being a second output unit.

### BACKGROUND OF THE INVENTION

1. Field of the Invention

The present invention relates to a color solid state image pickup device for picking up still pictures and for recording moving pictures.

2. Description of the Related Art

The color solid state image pickup device comprises a photoelectric conversion element array and a control unit for controlling reading-out of pixel data from the photoelectric conversion element array.

In the photoelectrical conversion element array, a plurality of photoelectrical conversion elements (pixels) are arranged in matrix. The photoelectrical conversion element array converts the optical image which make incidence thereto through an optical system into electric signals by photoelectrical conversion.

The control unit reads out pixel data from a group of pixels in the photoelectrical conversion element array.

The control unit has a whole-pixel-reading-out mode and a vertically/horizontally-mixed-pixel-reading-out mode for reading out the pixel data.

The whole-pixel-reading-out mode is a mode which reads out the pixel data of the whole pixels on the photoelectrical conversion element array at the time of picking up still pictures.

The vertically/horizontally-mixed-pixel-reading-out mode is a mode which reads out the pixel data by reducing the number of pixels to be the reading subject through mixing the pixel data of a plurality of pixels in the horizontal and vertical directions at the time of recording moving pictures.

As for the photoelectrical conversion element array of the color solid state image pickup device, the number of pixels has been dramatically increased due to developments in the semiconductor technology in recent years. A sufficiently large number of pixels are refereed to as being high pixels.

As for high-quality single lens reflex digital cameras, the ones with over 10,000,000 pixels are to be achieved with consideration of obtaining super fine still pictures.

In the meantime, as for digital movies capable of recording moving pictures, the sensitivity, resolution, color qualities, color resolution, and dynamic range are improved by mounting three-plate CCD for separately obtaining RGB signals from each CCD.

Recently, provided are the ones with a configuration having two functions of picking up still pictures and of recording moving pictures, in which the two modes can be switched.

For picking up still pictures, it is performed by using the pixel data of the whole pixels in the photoelectrical conversion element array. This is the whole-pixel-reading-out mode, which outputs the pixel data of the whole pixels read out from the photoelectrical conversion element array in order by each pixel. Thereby, it enables to pickup highly fine still pictures.

Meanwhile, there is also a solid state image pickup device with a configuration having two modes for picking up still pictures and for recording moving pictures, and both modes can be switched.

At present, there is a specific limit in the operation speed of the digital signal processing circuit. Moreover, regarding the power consumption, it is difficult to record moving pictures by the whole-pixel-reading-out mode similar to the one used at the time of picking up still pictures. In general, at the time of recording moving pictures, pixel data processing is carried out through thinning out the pixels and increasing the number of frames per unit time. This is the vertically/horizontally-mixed-pixel-reading-out mode.

As for the pixel data read out from the photoelectrical conversion element array, a plurality of pixels are mixed in the vertical and horizontal directions of the array, and the mixed pixel data is outputted as a single unit of pixel data. Thereby, the number of frames per unit time is increased so that it enables to perform smooth and fast recording of moving pictures.

Thinning out of the pixels, and switching of the mixed-pixel-reading-out mode and whole-pixel-reading-out mode as described above can be excellently achieved, especially, by a MOS image sensor, since it is possible to read out pixel data in any lines at will using signal lines, without having the MOS image sensor unlike CCD image sensors, so as to transfer electric potentials by transferring potential well. Further, the MOS image sensor is advantageous in respect that it can be operated with low voltage, bears less amount of current leak, has still larger numerical aperture compared to the CCD in the same size, has high sensitivity, can read out data easily compared to the CCD, etc. Especially, it is extremely advantageous in respect that it can select and read out pixels at will, and in terms of mixing the pixels.

The object of the present invention is to obtain higher quality of recorded moving pictures by the color solid state image pickup device with two modes which are a mode for picking up still pictures by high pixels and a mode for recording moving pictures with smooth movement, in which the two modes can be switched.

### SUMMARY OF THE INVENTION

The color solid state image pickup device of the present invention comprises the following two structural elements. One is a photoelectrical conversion element array and the other is a control unit for reading out the pixel data. The photoelectrical conversion element array is formed in matrix so as to converts optical images entering through an optical system into electric signals by photoelectrical conversion, and is configured to generate four colors of pixel data with a group of pixels in two lines and two rows being a unit. The four colors of pixel data herein may all be in the same color or the two may be in the same color. As an example of the case where the two are in the same color, there is Bayer pattern of GRBG (G is green, R is red, B is blue).

The control unit comprises four channels of output sections and a whole-pixel-reading-out mode and a vertically/horizontally-mixed-pixel-data-reading-out mode with four-channel-simultaneous-output system, in which the two modes can be switched.

As an output form, the above-described whole-pixel-reading-out mode, with a group of pixels in two lines and two rows in the photoelectrical conversion element array being a first output unit of the pixel data, through four channels of output sections, simultaneously outputs: pixel data of a first color pixel from a first output section; pixel data of a second color pixel from a second output section; pixel data of a third color pixel from a third output section; and pixel data of a fourth color pixel from a fourth output section. This is the mode for outputting the pixel data of the whole pixels in the photoelectrical conversion element array as a result of scanning the output form as described above by the first output unit.

As an output form, the above-described vertically/horizontally-mixed-pixel-reading-out mode, with a group of pixels in 2n lines and 2n rows (n is set to be natural number of 2 or larger) being a second output unit of the pixel data, mixes the pixel data of the groups of n×n numbers of pixels in the same color in the second output unit by each color, and then, through four channels of output sections, simultaneously outputs: mixed pixel data of a first color pixel from a first output section; mixed pixel data of a second color pixel from a second output section; mixed pixel data of a third color pixel from a third output section; and mixed pixel data of a fourth color pixel from a fourth output section. This is the mode for outputting the pixel data in which the pixels are thinned out by scanning the output form as described over the entire portion of the photoelectrical conversion element array by the second output unit.

The first, second, third, fourth colors in the above-described configuration may all be different or the two may be the same color (for example, Bayer pattern of GRBG) as described above.

In the above-described configuration, for example, if n=3, the second output unit becomes a group of pixels in six lines and six rows. The group of pixels in six lines and six rows contains thirty-six pixels. When the group of pixels in two lines and two rows as the first output unit is, for example, Bayer pattern of GRBG, the group of pixels in six lines and six rows contains nine first G (green) pixels, nine R (red) pixels nine B (blue) pixels, and nine second G (green) pixels. Since n×n=9, when n=3.

The pixel data of the nine first G (green) pixels are mixed to be the first G data with mixed nine pixels so as to be outputted from the first channel. At the same time, the pixel data of the nine R (red) pixels are mixed to be the R data with mixed nine pixels so as to be outputted from the second channel. At the same time, the pixel data of the nine B (blue) pixels are mixed to be the B data with mixed nine pixels so as to be outputted from the third channel and, at the same time, the pixel data of the nine second G (green) pixels are mixed to be the second G data with mixed nine pixels so as to be outputted from the fourth channel.

That is, the first G data with mixed nine pixels, the R data with mixed nine pixels, the B data with mixed nine pixels, and the second G data with mixed nine pixels are outputted simultaneously and separately from each other. The original thirty-six pixels of data are put together in four data. As for the channel unit, each channel outputs one pixel data for the original thirty-six pixels. The output form of the pixel data in which the nine pixels are mixed for thinning out as described above is scanned over the entire portion of the photoelectrical conversion element array by the second output unit with a group of pixels in six lines and six rows. That is, the pixels are thinned out by ⅙ in the horizontal direction and also by ⅙ in the vertical direction.

Now, as an example of the high pixel of over 10,000,000 pixels, the total of about 11,060,000 pixels with 3,840 pixels in the horizontal direction and 2,880 pixels in the vertical direction will be considered. When the pixels of about 11,060,000 are sectioned into groups of pixels in six lines and six rows, it becomes VGA (Video Graphics Array) as the moving picture mode standard with 640 pixels in the horizontal direction and 480 pixels in the vertical direction.

Not only in the case where n=3, but also in general, it can be summarized as follows. The second output unit becomes a group of pixels in 2n lines and 2n rows. The group of pixels in 2n lines and 2n rows contains 4n² pixels. When the group of pixels in two lines and two rows as the first output unit is, for example, the Bayer pattern of GRBG, the group of pixels in 2n lines and 2n rows contains n² first G (green) pixels, n² R (red) pixels, n² B (blue) pixels, and n² second G (green) pixels.

The pixel data of the n² first G (green) pixels are mixed to be the first G data with mixed n² pixels so as to be outputted from the first channel. At the same time, the pixel data of the n² R (red) pixels are mixed to be the R data with mixed n² pixels so as to be outputted from the second channel. At the same time, the pixel data of the n² B (blue) pixels are mixed to be the B data with mixed n² pixels so as to be outputted from the third channel and, at the same time, the pixel data of the n² second G (green) pixels are mixed to be the second G data with mixed n² pixels so as to be outputted from the fourth channel.

That is, the first G data with mixed n² pixels, the R data with mixed n² pixels, the B data with mixed n² pixels, and the second G data with mixed n² pixels are outputted simultaneously and separately from each other. The original 4n² pixels of data are put together in four data. As for the channel unit, each channel outputs one pixel data for the original 4n² pixels. The output form of the pixel data in which the n² pixels are mixed for thinning out as described above is scanned over the entire portion of the photoelectrical conversion element array by the second output unit with a group of pixels in 2n lines and 2n rows. That is, the pixels are thinned out by 1/(2n) in the horizontal direction and also by 1/(2n) in the vertical direction. The simultaneous separate and parallel output of the mixed pixel data through four channels is to be referred to as GRBG virtual four-plate reading out system.

In general, the size of the photoelectrical conversion element array in the case of n, for achieving the GRBG virtual four-plate reading out system with 640 pixels in the horizontal direction and 480 pixels in the vertical direction, may be 640 in the horizontal direction×2n pixels×480 in the vertical direction×2n pixels, which can be obtained by calculation. When n=4, it may be the total of about 19,700,000 pixels with 5,120 pixels in the horizontal direction and 3,840 pixels in the vertical direction. When N=5, it may be the total of about 30,700,000 pixels with 6,400 pixels in the horizontal direction and 4,800 pixels in the vertical direction. It may also be applied to the case where n=2.

Conventionally, generally used as VGA is a RGB three-plate system. On the contrary, the present invention with the above-described configuration employs the GRBG virtual four-plate reading out system with four channels of output sections. This means that, compared to the related art, improvement in the quality of moving pictures is achieved.

It is not necessary to limit the moving picture mode to VGA. If the moving picture mode is NH pixels in the horizontal direction and NV pixels in the vertical direction with NH and NV being natural numbers, the size of the photoelectrical conversion element array may be NH in the horizontal direction×2n pixels×NV in the vertical direction×2n pixels.

The combination of colors of the group of pixels in two lines and two rows constituting the photoelectrical conversion element array may be complementary colors of cyanogens, magenta, yellow and green.

In addition, there is a following advantage in the improvement in the quality of the moving pictures. The optical cell of the image sensor mounted onto a conventional and general digital movie is usually small. On the contrary, the optical cell of the image sensor mounted onto a high quality digital still camera with high pixel is large. In the image sensor fabricated using the large optical cell as the base, the pixels are thinned out as described above. Thus, more excellent quality of the moving pictures can be achieved.

The preferable configuration of the above-described control unit will be specifically described in the followings. That is, the control unit has a configuration, comprising: a vertical transfer switch circuit for two lines for reading out the pixel data from the photoelectrical conversion element array; a signal voltage holding circuit for two lines for temporarily holding the read-out data; a horizontal transfer switch circuit for two lines for outputting the pixel data or the mixed pixel data from the signal voltage holding circuit by dividing the data to two channels each; an output amplifier with four channels for outputting, from said horizontal shift selection circuit, a total of four pixel data or mixed-pixel data separately and in parallel with respect to each other; and a horizontal shift selection circuit for switching output by the whole-pixel-reading-out mode and output by the mixed-pixel-reading-out mode by controlling the horizontal transfer switch circuit.

### BRIEF DESCRIPTION OF THE DRAWINGS

The present invention is illustrated be way of example and not limitation in the figures of the accompanying drawings, in which like references indicate similar elements and in which:

FIG. 1 is a block diagram showing the basic configuration of a color solid state image pickup device according to the preferred embodiment of the present invention;

FIG. 2 is a model illustration for describing action of the whole-pixel-reading-out mode;

FIG. 3 is a model illustration for describing action of the vertically/horizontally-mixed-pixel-reading-out mode;

FIG. 4 is a block diagram showing more specific configuration of the color solid state image pickup device;

FIG. 5 is a detailed block diagram of a noise removing/pixel selection circuit of the color solid state image pickup device shown in FIG. 4;

FIG. 6 is a partly taken-out enlarged block diagram of the photoelectrical conversion element array of the color solid state image pickup device shown in FIG. 4;

FIG. 7 is an enlarged illustration of the circuit part of the color solid state image pickup device shown in FIG. 4, for reading out the pixel data of the pixels on the first scanning line by the whole-pixel-reading-out mode;

FIG. 8 is an enlarged illustration of the circuit part of the color solid state image pickup device shown in FIG. 4, for reading out the pixel data of the pixels on the second scanning line by the whole-pixel-reading-out mode;

FIG. 9 is an enlarged illustration of the circuit part of the color solid state image pickup device shown in FIG. 4, for reading out the pixel data of the pixels on the first scanning line by the mixed-nine-pixel-reading-out mode; and

FIG. 10 is an enlarged illustration of the circuit part of the color solid state image pickup device shown in FIG. 4, for reading out the pixel data of the pixels on the second scanning line by the mixed-nine-pixel-reading-out mode.

### DETAILED DESCRIPTION OF PREFERRED EMBODIMENTS OF THE INVENTION

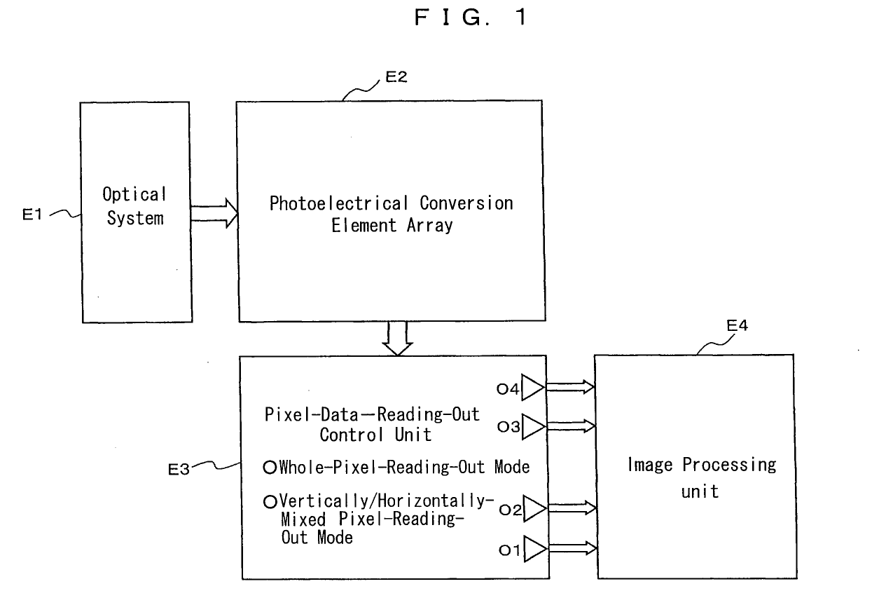

By referring to the accompanying drawings, the color solid state image pickup device according to the preferred embodiments of the invention will be described in detail. FIG. 1 is a basic block diagram of the color solid state image pickup device.

In FIG. 1, numeral reference E1 is an optical system to which optical image of object makes incidence. The optical system E1 comprises a plurality of combination lenses.

E2 is a photoelectrical conversion element array. The photoelectrical conversion element array E2 comprises a plurality of photoelectrical conversion elements (pixels) arranged in matrix. Further, each of the photoelectrical conversion elements performs photoelectrical conversion on incident light entered through the optical system E1 for generating pixel data. The optical image of the object is formed by the incident light from the optical system E1 over the entire portion of the photoelectrical conversion elements.

The photoelectrical conversion element array E2 comprises a color filter. E3 is a control unit for controlling reading-out of pixel data. The control unit E3 reads out the pixel data from the photoelectrical conversion element array E2, and also outputs the read-out data by switching two modes. One of the two modes is a mode for reading out the whole pixels at the time of picking up still pictures, and the other is a mode for reading out vertically/horizontally mixed pixels (mode for reading out mixed pixels) at the time of recording moving pictures.

(1) The whole-pixel-reading-out mode at the time of picking up still pictures is a mode in which whole pixels of the read-out data is outputted in order by each pixel.

(2) The mixed-pixel-reading-out mode at the time of recording moving pictures is a mode in which the read-out data is mixed in the vertical and horizontal directions of the array for a plurality of pixels, and the mixed data is outputted.

The control unit E3 comprises four channels of output sections ◯1, ◯2, ◯3, ◯4 as the sections for outputting the pixel data.

The output sections ◯1, ◯1, ◯3, ◯4 output the pixel data in parallel at the time of the whole-pixel-reading-out mode, in which each pixel is separated from each other. Moreover, the output sections ◯1, ◯2, ◯3, ◯4 are configured to output the pixel data in parallel at the time of the mixed-pixel-reading-out mode, in which each pixel is separated from each other.

E4 is an image processing unit. The image processing unit E4 performs a desired data processing upon receiving input of the pixel data outputted from the control unit E3.

The operation will be described.

The mixed-pixel-reading-out mode is set. The optical image of the object formed on the photoelectrical conversion element array E2 through the optical system E1 is converted to electric signal in the photoelectrical conversion element array E2 by photoelectrical conversion.

The specific action up to this point is as follows.

The control unit E3 reads out the pixel data from the photoelectrical conversion element array E2. The image processing unit E4 performs processing of CDS (correlated double sampling) onto the inputted pixel data for removing reset noise and low frequency noise. Further, AGC (automatic gain control) is performed for further converting analog signal to digital data.

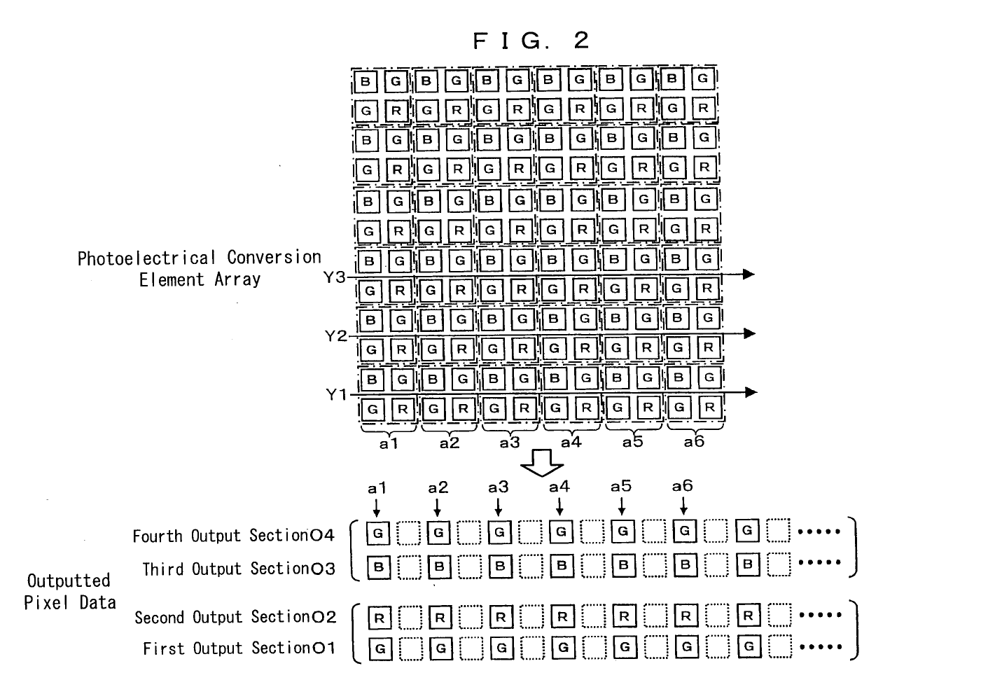

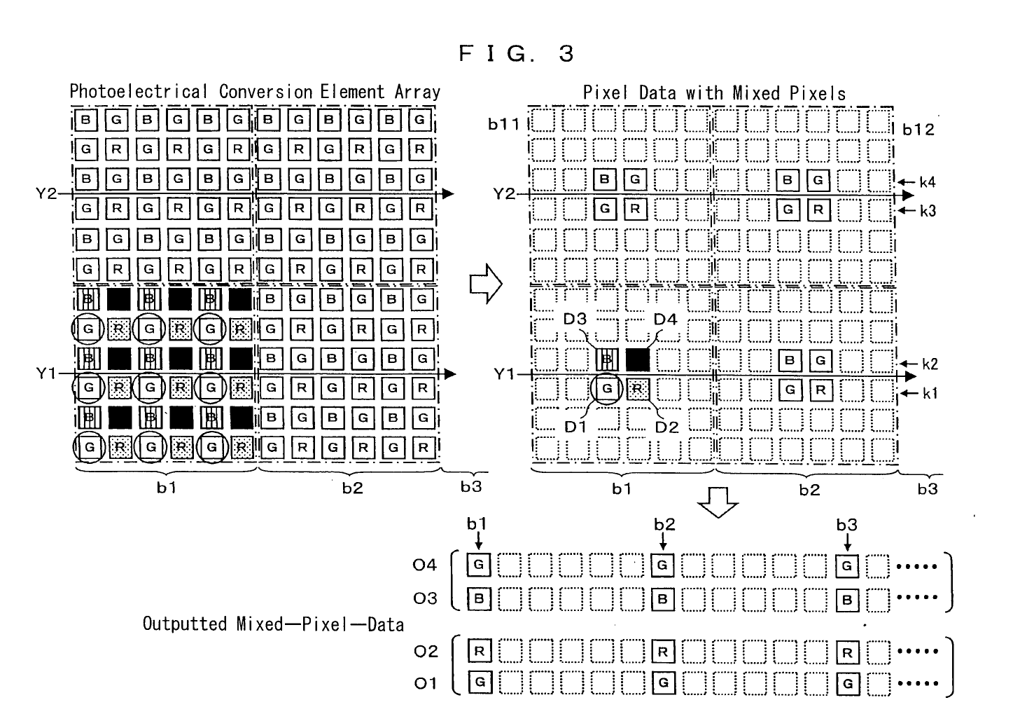

Next, by referring to FIG. 2 and FIG. 3, the whole-pixel-reading-out mode and the mixed-pixel-reading-out mode will be described more specifically.

FIG. 2 and FIG. 3 are model illustrations for clearly showing an example of each reading-out mode.

In FIG. 2, the upper side shows a part of the photoelectrical conversion element array E2 and the lower side is the pixel data outputted by the control unit E3.

In FIG. 3, the left side shows a part of the photoelectrical conversion element array E2, the upper right side is the pixel data in which the pixels are mixed by the control unit 3E, and the lower right side is the outputted mixed pixel data.

The photoelectrical conversion element array E2 is in Bayer pattern in which first G (green), R (red), B (blue), and second G (green) are arranged.

First, the whole-pixel-reading-out mode will be described by referring to the model illustration shown in FIG. 2. All the pixel data of the whole pixels in the photoelectrical conversion element array E2 are outputted. The mode herein is the one used at the time of picking up still pictures.

A group of pixels a1, a2, a3—in two lines and two rows, which is composed of the four pixels of GRBG as the basic structural elements of the Bayer pattern, is set to be a first output unit of the pixel data.

The output form in which the pixel data in each color of the first output unit is outputted is scanned by the first output unit simultaneously in the horizontal and vertical directions using the output sections ◯1, ◯2, ◯3, ◯4. By this scanning, the pixel data of the whole pixels in the photoelectrical conversion element array E2 are outputted. Scanning is performed by a scanning unit of two adjacent horizontal scanning lines in order from an arrow Y1, to an arrow Y2, and to an arrow Y3. Specifically, it is performed as follows.

In a1 of the first output unit as the first scanning unit of two scanning lines shown by Y1, the pixel data of first G (green) pixel as the first color pixel is outputted from the first output section ◯1 and, at the same time, the pixel data of R (red) pixel as the second color pixel is outputted from the second output section ◯2. Simultaneously, the pixel data of B (blue) pixel as the third color pixel is outputted from the third output section ◯3 and, at the same time, the pixel data of the second G (green) is outputted from the fourth output section ◯4.

Subsequently, proceeding to the next output unit in the horizontal direction to be in a2 of the first output unit, as in the same manner as described above, output of the first G (green) pixel data from the first output section ◯1, output of the R (red) pixel data from the second output section ◯2, output of the B (blue) pixel data from the third output section ◯3, and output of the second G (green) pixel data from the fourth output section ◯4 are performed simultaneously.

Then, proceeding to the next output unit in the horizontal direction to be in a3 of the first output unit, as in the same manner as described above, the first G (green) pixel data, the R (red) pixel data, the B (blue) pixel data, and the second G (green) pixel data, which are separated from each other, are outputted simultaneously from the first to fourth output sections ◯1, ◯2, ◯3, ◯4.

In the same manner, by proceeding to the next unit in the horizontal direction in order as the first output unit, separate and parallel output of the GRBG pixel data is performed by the first output unit from the four channels of output sections ◯1, ◯2, ◯3, ◯4. When all the separate and parallel output of the GRBG pixel data for the first scanning unit are completed, it then proceeds to the adjacent scanning unit of Y2 and scanning is performed in the horizontal and vertical directions in the same manner. Thereby, separate and parallel output of the GRBG pixel data is performed by the first output unit over the whole pixels of the photoelectrical conversion element array E2.

In the whole-pixel-reading-out mode, the pixel data of the whole pixels in the photoelectrical conversion element array E2 are used so that highly fine still pictures can be picked up with high pixels.

Next, the mixed-pixel-reading-out mode will be described by referring to the model illustration shown in FIG. 3. The mixed pixel data is outputted under the state where the pixels in the photoelectrical conversion element pixel E2 are thinned out. This mode is the one used at the time of recording moving pictures.

Pixel data of b1, b2, b3—in six lines and six rows composed of nine groups of pixels in two lines and two rows which are composed of four pixels of GRBG is set as the second output unit.

In the pixel data shown in the upper right of FIG. 3, in which the pixels are mixed, there are two G (green) mixed pixel data, and R (red) and B (blue) mixed pixel data in the second output unit which is composed of a group of thirty-six pixels in six lines and six rows.

A single G (green) pixel data marked by circle among the mixed pixel data is the data in which pixel data of nine G (green) pixels marked by circles on the photoelectrical conversion element array are mixed.

The R (red) pixel data among the mixed pixel data, which is on the right side of the pixel data marked by circle, is the data in which the nine R (red) pixels on the photoelectrical conversion element array on the right side of the nine pixel data marked by circles are mixed.

The B (blue) pixel data among the mixed pixel data, which is on the upper side of the pixel data marked by circle, is the data in which the nine B (blue) pixels on the photoelectrical conversion element array on the upper side, respectively, of the nine pixel data marked by circles are mixed.

The G (green) pixel data among the mixed pixel data, which is diagonal with respect to the pixel data marked by circle, is the data in which the nine G (green) pixels on the photoelectrical conversion element array, which, respectively, are diagonal with respect to the nine pixel data, are mixed. These patterns are repeated with the total of thirty-six arrays in six lines and six rows being one unit.

In the thirty-six pixels of the photoelectrical conversion element array E2, there are eighteen G pixels, and nine R pixels and nine B pixels. As the pixel data, they are turned to be two, one, and one in number, respectively. That is, they are thinned out by ⅓ in the horizontal direction, ⅓ in the vertical direction, thereby being thinned out by 1/9 as a whole. Each of these mixed pixel data is to be outputted from a single channel, totaling four channels, so that it is to be thinned out by 1/36 per channel.

Moreover, the outputted mixed pixel data after being thinned out is similar to the original Bayer pattern, thereby keeping the Bayer pattern. Specifically, the first line (k1) of the mixed pixel data goes G, R, G, R—, the second line (k2) goes B, G, B, G—, the third line (k3) goes G, R, G, R—, and the fourth (k4) line goes B, G, B, G.

The output form, in which the mixed pixel data as shown in FIG. 3 on the upper right side are outputted by each color in the second output unit simultaneously using the output sections ◯1, ◯2, ◯3, ◯4 so as to be outputted as the mixed pixel data as shown in FIG. 3 on the lower right side, is scanned in the horizontal and vertical directions by the second output unit. By this scanning, the mixed pixel data is outputted under the state where the pixels are thinned out. Scanning is performed by a scanning unit of adjacent six horizontal scanning lines as a pair in order from an arrow Y1 to an arrow Y2. The specific action is as follows.

In b1 of the second output unit as the first scanning unit of six scanning lines shown by Y1, the mixed pixel data of first G (green) pixel as the first color pixel is outputted from the first output section ◯1 and, at the same time, the mixed pixel data of R (red) pixel as the second color pixel is outputted from the second output section ◯2. Simultaneously, the mixed pixel data of B (blue) pixel as the third color pixel is outputted from the third output section ◯3 and, at the same time, the mixed pixel data of the second G (green) is outputted from the fourth output section ◯4.

Subsequently, proceeding to the next output unit in the horizontal direction to be in b2 of the second output unit, as in the same manner as described above, output of the first G (green) mixed pixel data from the first output section ◯1, output of the R (red) mixed pixel data from the second output section ◯2, output of the B (blue) mixed pixel data from the third output section ◯3, and output of the second G (green) mixed pixel data from the fourth output section ◯4 are performed simultaneously.

Then, proceeding to the next output unit in the horizontal direction to be in b3 of the second output unit, as in the same manner as described above, the first G (green) mixed pixel data, the R (red) mixed pixel data, the B (blue) mixed pixel data, and the second G (green) pixel data, which are separated from each other, are outputted simultaneously from the first to fourth output sections ◯1, ◯2, ◯3, ◯4.

In the same manner, by proceeding to the next unit in the horizontal direction in order as the first output unit, separate and parallel output of the GRBG mixed pixel data is performed by the second output unit from the output sections ◯1, ◯2, ◯3, ◯4. When all the separate and parallel output of the GRBG mixed pixel data for the first scanning unit is completed, it then proceeds to the adjacent scanning unit of Y2 and scanning is performed in the horizontal and vertical directions in the same manner. Thereby, separate and parallel output of the GRBG mixed pixel data is performed over the whole pixels of the photoelectrical conversion element array E2 after thinning out the pixels by the second output unit.

In the outputted pixel data shown in FIG. 2 and the outputted mixed pixel data shown in FIG. 3, the distance in the horizontal direction shows the relations of spatial positioning on the photoelectrical conversion element array and is not a time base coordinate. As for the time, the output rate of the pixel data is basically the same in FIG. 2 and FIG. 3.

As described above, in the second output unit composed of a group of pixels in six lines and six rows, mixed pixel data of each color is outputted by each color through each channel of output section. Thus, it is reduced by 1/36 in each channel two-dimensionally in horizontal and vertical directions.

Accordingly, the color solid state image pickup device according to the embodiment employs a virtual four-plate reading system which performs separate and parallel output of GRBG mixed pixel data from four channels simultaneously. Thus, it enables to record fine moving pictures with smooth movement with high pixels.

In recording moving pictures, since the mixed pixel data which has been thinned out is outputted and, in addition, the optical cell size becomes large because of high pixels, the quality of the moving pictures can be dramatically improved compared to the related art.

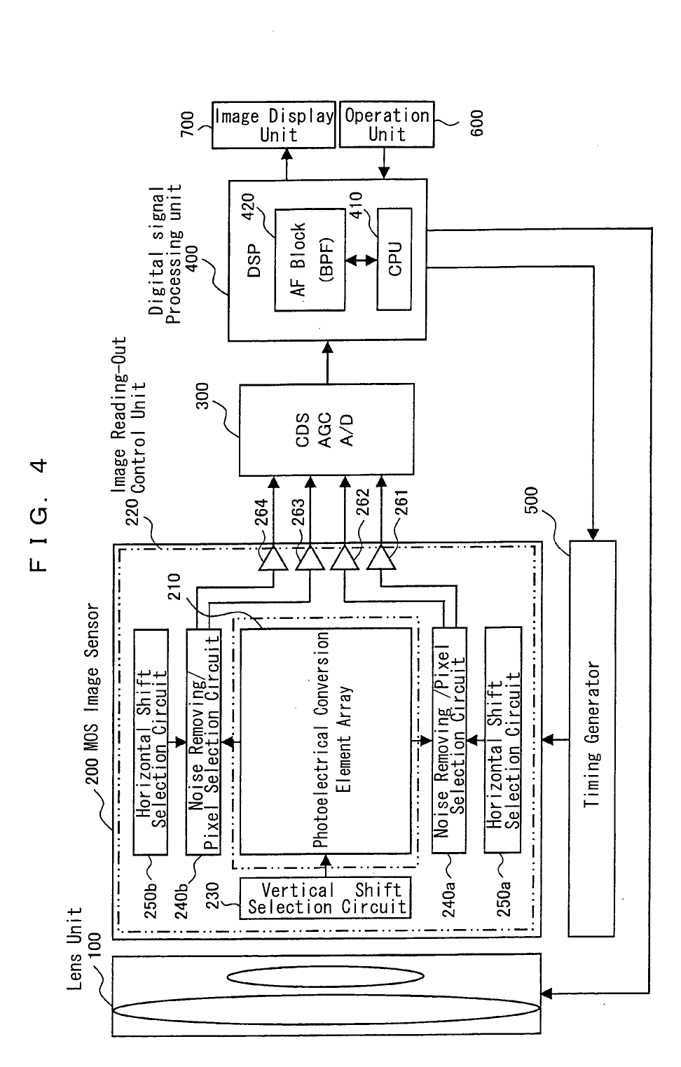

FIG. 4 is a circuit block diagram of the color solid state image pickup device, which more specifically illustrates the configuration of FIG. 1 described above.

In FIG. 4, numeral 100 is a lens unit, 200 is a MOS image sensor, 300 is a CDS-AGC-A/D processing unit, 400 is a digital signal processing unit, 500 is a timing generator, 600 is a operation unit, and 700 is a screen display. The lens unit 100 corresponds to the optical system E1.

The MOS image sensor 200 comprises a photoelectrical conversion element array 210 and a pixel-data-reading-out control unit 220.

The photoelectrical conversion element array 210 corresponds to the photoelectrical conversion element array E2 and the control unit 220 corresponds to the control unit E3.

The control unit 220 comprises a vertical shift selection circuit 230, upper and lower noise removing/pixel selection circuits 240a, 240b, upper and lower horizontal shift selection circuits 250a, 250b, and output amplifiers 261, 262, 263, 264 for four channels.

The CDS-AGC-A/D processing unit 300 and the digital signal processing unit 400 correspond to the image processing unit E4. The digital signal processing unit 400 comprises a CPU 410 and an AF block 420.

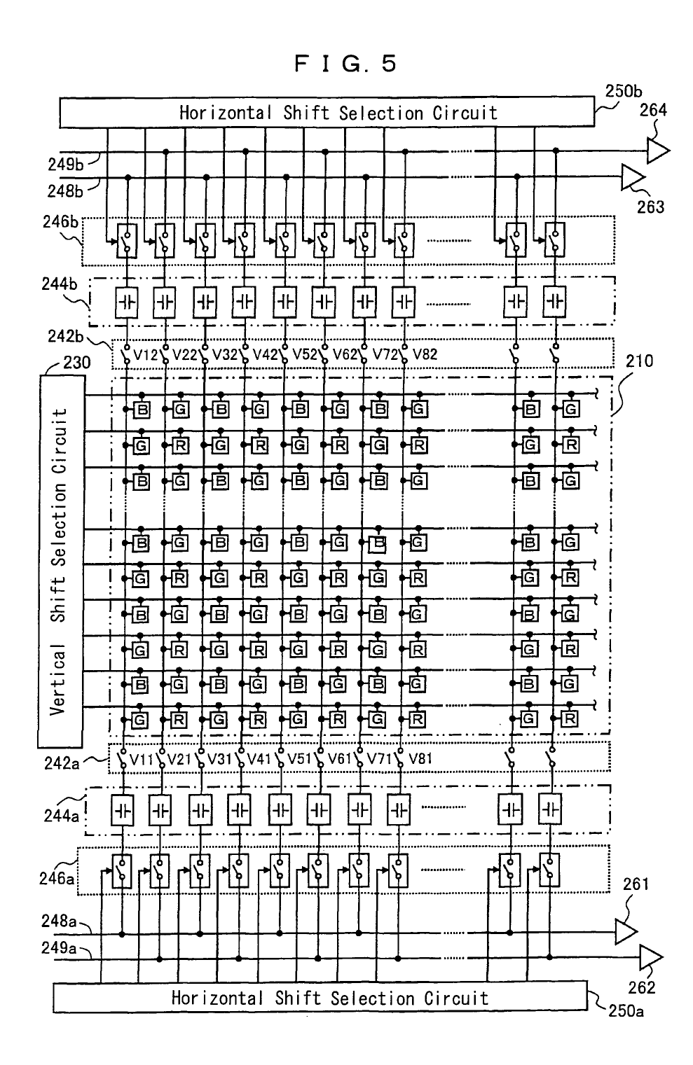

FIG. 5 is a block diagram showing the more detailed configuration of the noise removing/pixel selection circuit 240. In FIG. 5, numeral reference 242a, 242b are vertical transfer switch circuits, 244a, 244b are signal voltage holding circuits, 246a, 246b are horizontal transfer switch circuits, 248a is a signal output line towards the first output amplifier 261, 249a is a signal output line towards the second output amplifier 262, 248b is a signal output line towards the third output amplifier 263, and 249b is a signal output line towards the fourth output amplifier 264.

The vertical shift selection circuit 230 selects the scanning unit, that is, two horizontal scanning lines. For reading out the pixel data of the pixels on the first scanning line, the vertical transfer switch circuit 242a, the signal voltage holding circuit 244a, the horizontal transfer switch circuit 246a, the horizontal shift selection circuit 250a, the signal output lines 248a, 249a and the output amplifiers 261, 262 are constituted on the lower side. And for reading out the pixel data of the pixels on the second scanning line, the vertical transfer switch circuit 242b, the signal voltage holding circuit 244b, the horizontal transfer switch circuit 246b, the horizontal shift selection circuit 250b, the signal output lines 248b, 249b and the output amplifiers 263, 264 are constituted on the upper side.

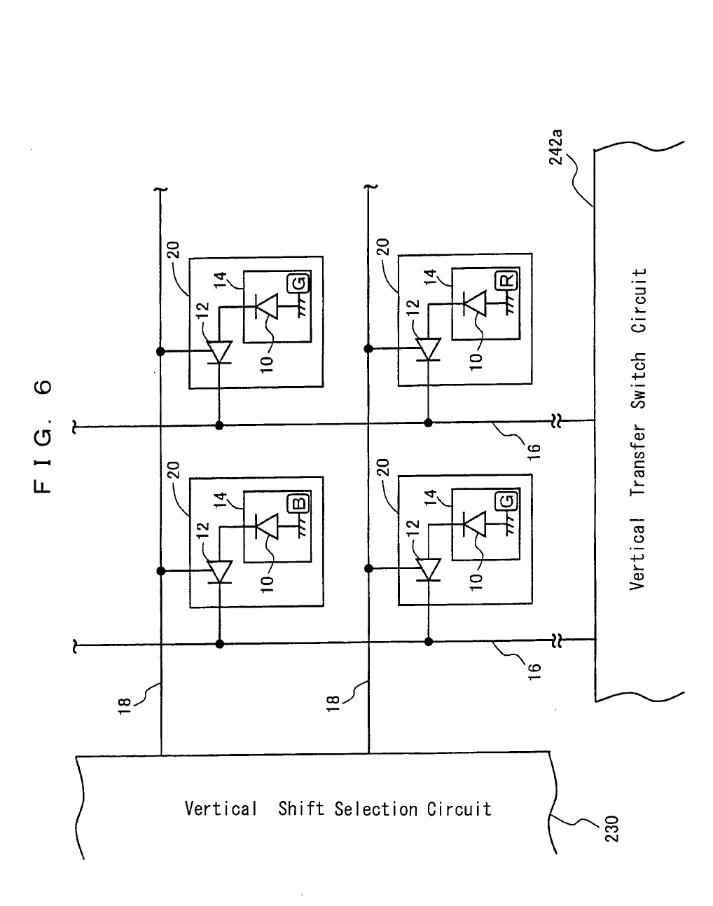

FIG. 6 is a partly-taken-out enlarged view of the photoelectrical conversion element array 210. A single pixel 20 is composed of a photodiode 10, a cell amplifier 12 and a color filter 14. Anode of the photodiode is earthed, cathode is connected to the input of the cell amplifier 12, and the output of the cell amplifier 12 is connected to a pixel data reading out line 16 in the longitudinal direction. The control terminal of the cell amplifier 12 is connected to a scanning line 18 of the vertical shift selection circuit 230.

The color filter 14 is disposed in front of the photodiode 10. The color filter 14 is configured to form a Bayer pattern (G, R, B, G) with four pixels as a pair. As a unit with four pixels in two lines and two rows, the first G (green) and R (red), and B (blue) and the second G (green) are lined in the horizontal direction, while the first G (green) and B (blue), and R (red) and the second G (green) are lined in the vertical direction. Large numbers of the unit of four pixels are arranged in crosswise matrix form.

(Whole-Pixel-Reading-Out Mode)

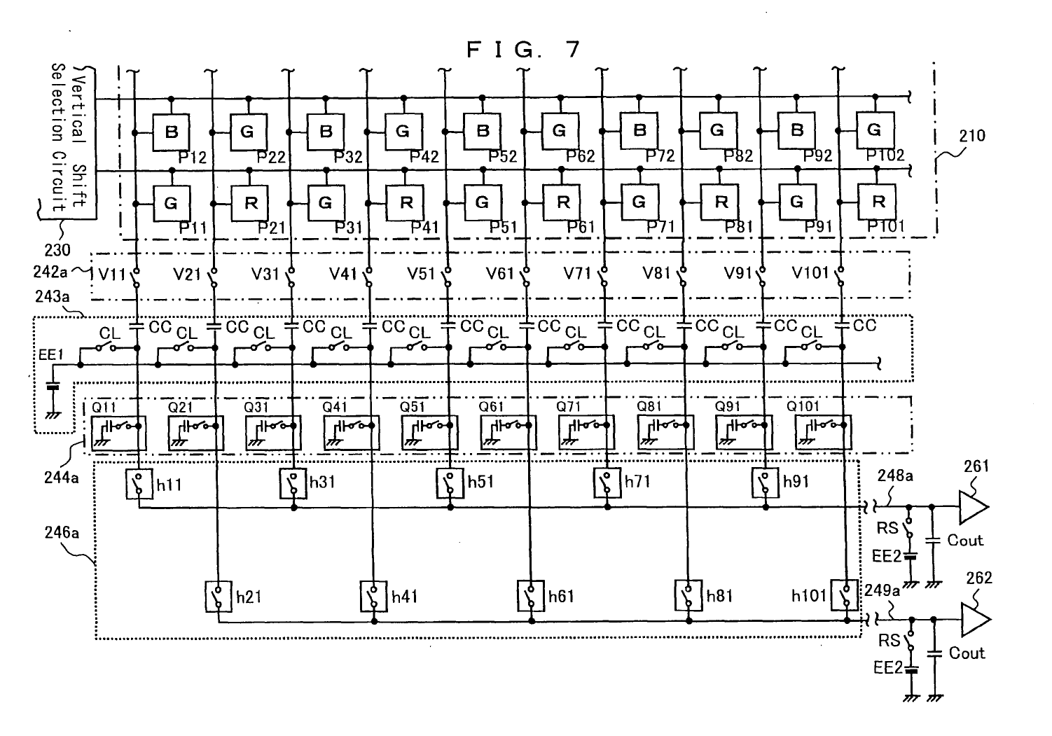

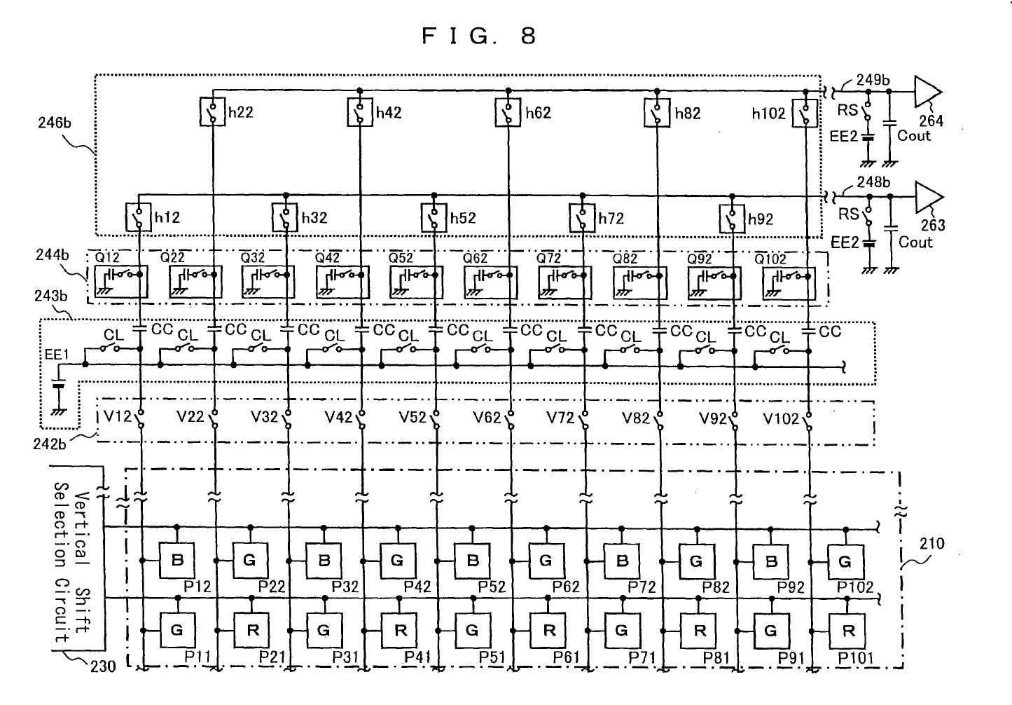

Action of the whole-pixel-reading-out mode will be described by referring to FIG. 7 and FIG. 8. FIG. 7 shows an enlarged view of the circuit configuration part for reading out the pixel data of the pixels on the first scanning line. FIG. 8 is an enlarged view of the circuit configuration part for reading out the pixel data of the pixels on the second scanning line. In the drawings, the noise removing circuit 243a, 243b are also illustrated (not shown in FIG. 5). The group of pixels on the first line and the group of pixels on the second line of the photoelectrical conversion element array 210 shown in FIG. 7 are also illustrated in FIG. 8.

In the first stage of reading out the first pixel unit, reset switches RS in front of the output amplifiers 261, 262, 263, 264 are closed once so that signal output condensers Cout are reset to have VDD level of reset electric source EE2. After the reset, the reset switches RS are opened. Further, clamp switches CL of the noise removing circuits 243a, 243b are once closed and all clamp condensers CC are reset. After the reset, the clamp switches CL are opened.

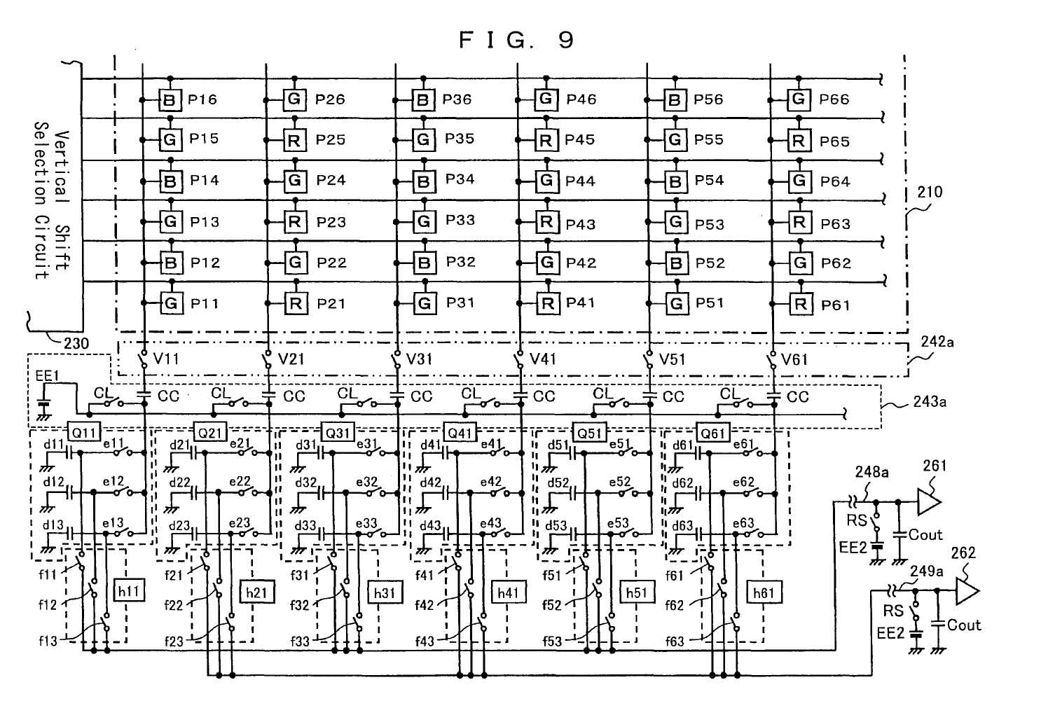

The first line of the photoelectrical conversion element array 210 is selected by the vertical shift selection circuit 230. All vertical transfer switches V11, V21, V31, V41—in the vertical transfer switch circuit 242a on the lower side are closed simultaneously. At this time, the clamp switches CL of the noise removing circuit 243a, 243b are once closed for resetting all the clamp condensers CC. After the reset, the clamp switches CL are opened and, then, voltage signals in pixels P11, P21, P31, P41—on the first line are charged, respectively, to condensers Q11, Q21, Q31, Q41—of the signal voltage holding circuit 244a on the lower side. The condenser Q11 herein is simply illustrated, but corresponds to all or one of three condensers d11, d12, d13 shown in FIG. 9. This is also the same for condensers Q21, Q31, Q41—and the like.

Then, the second line of the photoelectrical conversion element array 210 is selected by the vertical shift selection circuit 230. All vertical transfer switches V12, V22, V32, V42—in the vertical transfer switch circuit 242b on the upper side are closed simultaneously. Then, voltage signals in pixels P12, P22, P32, P42—on the second line are charged, respectively, to condensers Q12, Q22, Q32, Q42—of the signal voltage holding circuit 244b on the upper side. The condenser Q12 herein is simply illustrated, but corresponds to all or one of three condensers u11, u12, u13 shown in FIG. 9. This is also the same for condensers Q22, Q32, Q42—and the like.

Thereby, the first line and the second line are selected and the pixel data of the whole pixels on the two scanning lines are to be accumulated on each condenser of the signal voltage holding circuits 244a, 244b on the upper and lower sides. That is, it is ready for simultaneously performing separate and parallel output of the pixel data of a group of pixels in two lines and two rows through four channels.

Next, it proceeds to scanning of the separate and parallel output of four pixel data of GRBG through the four channels by the first output unit composed of a group of pixels in two lines and two rows in the first scanning unit with two lines as a pair.

First, in the horizontal transfer switch circuit 246a, 246b on the upper and lower sides, a horizontal transfer switch h11 of the first channel, a horizontal transfer switch h21 of the second channel, a horizontal transfer switch h12 of the third channel, and a horizontal transfer switch h22 of the fourth channel are closed simultaneously by timing control signals outputted from the horizontal shift selection circuits 250a, 250b on the upper and lower sides so as to output four pixel data of GRBG from the output amplifiers 261, 262, 263, 264 of the four channels. The horizontal transfer switch h11 herein is simply illustrated, but corresponds to all or one of three horizontal transfer switches f11, f12, f1 shown in FIG. 9. This is also the same for the horizontal transfer switch h22.

Specifically, when the horizontal transfer switch h11 of the first channel is closed, the pixel data of the G (green) pixel P11 on the first line and first row held in the condenser Q11 is outputted through the output condenser Cout and the output amplifier 261 of the first channel.

At the same time, when the horizontal transfer switch h21 of the second channel is closed, the pixel data of the R (red) pixel P21 on the first line and second row held in the condenser Q21 is outputted through the output condenser Cout and the output amplifier 262 of the second channel.

At the same time, when the horizontal transfer switch h12 of the third channel is closed, the pixel data of the B (blue) pixel P12 on the second line and first row held in the condenser Q12 is outputted through the output condenser Cout and the output amplifier 263 of the third channel.

At the same time, when the horizontal transfer switch h22 of the fourth channel is closed, the pixel data of the G (green) pixel P22 on the second line and second row held in the condenser Q22 is outputted through the output condenser Cout and the output amplifier 264 of the fourth channel.

Thereby, separate and parallel output of the pixel data by the first output unit a1 with four pixels of GRBG in the first scanning unit in FIG. 2 is performed simultaneously through four channels.

Hereinafter, next horizontal pixel is read out after resetting the signal output condensers Cout by the reset switches RS. The reset is performed by output of each pixel data of a single pixel.

Subsequently, by the timing control signal outputted from the horizontal shift selection circuits 250a, 250b on the upper and lower sides, the horizontal transfer switches which are to be closed simultaneously in the horizontal transfer switch circuits 246a, 246b on the upper and lower sides are brought forward by two rows.

That is, the horizontal transfer switch h31 of the first channel, the horizontal transfer switch h41 of the second channel, the horizontal transfer switch h32 of the third channel, and the horizontal transfer switch h42 of the fourth channel are closed simultaneously.

Thereby, simultaneously, the pixel data of the G (green) pixel P31 on the first line and third row held by the condenser Q31 is outputted from the output amplifier 261 of the first channel, the pixel data of the R (red) pixel P41 on the first line and fourth row held by the condenser Q41 is outputted from the output amplifier 262 of the second channel, the pixel data of the B (blue) pixel P32 on the second line and third row held by the condenser Q32 is outputted from the output amplifier 263 of the third channel, and the pixel data of the G (green) pixel P42 on the second line and fourth row held by the condenser Q42 is outputted from the output amplifier 264 of the fourth channel. Thereby, separate and parallel output of the pixel data by the first output unit a2 with four pixels of GRBG in the first scanning unit in FIG. 2 is performed simultaneously through four channels.

Hereinafter, by the timing control signals outputted from the horizontal shift selection circuits 250a, 250b, the transfer switches which are to be closed simultaneously in the horizontal transfer switch circuits 246a, 246b are brought forward in order by two rows and the same operations are carried out. Thereby, separate and parallel output of the pixel data of the four pixels of GRBG through four channels can be executed simultaneously for the first output unit of a3, a4, a5, a6—in order. Thereby, reading out of the pixel data of the whole pixels on the first scanning unit can be completed.

When the simultaneous separate and parallel output of the GRBG pixel data for the whole pixels on the first scanning unit through the four channels is completed, the operation is then shifted to perform reading out of the pixel data of the second scanning unit, after canceling the noise. That is, by applying the direct current electric source EE1 for the clamp through closing all the clamp switches CL, all the clamp condensers CC are reset to initial electric potential.

The pixels are formed by a combination of photodiode and a cell amplifier (floating-diffusion amplifier). The electric potential accumulated in the photodiode is outputted in the form of voltage through the cell amplifier. There is a difference between the threshold values of the voltages VT of the transistors of the cell amplifier, which becomes the offset component for deteriorating the picture quality (for example, vertical lines). This is called a noise and it is a roll of the noise removing circuits 243a, 243b to cancel the noise. As the clamp condenser, MOS gate capacity can be used. After resetting the clamp condenser, the clamp switches CL are released and the operation is shifted to read out the pixel data of the next scanning unit.

At the time of reading out the pixel data of the next scanning unit, after going through vertical shift in the vertical shift selection circuit 230 within a horizontal blanking period, reading-out is performed twice therefore to proceeds by one to the scanning unit to be selected. The same operation as described above is repeated hereinafter for executing the simultaneous separate and parallel output of the GRBG pixel data for the whole pixels of one scanning unit through four channels.

Then, by proceeding by one to the selected scanning unit, the simultaneous separate and parallel output of the GRBG pixel data is executed through four channels, and is repeated until the last scanning unit. Thereby, the whole pixel data for one frame is outputted simultaneously through the four channels.

(Mixed-Nine-Pixel-Reading-Out Mode)

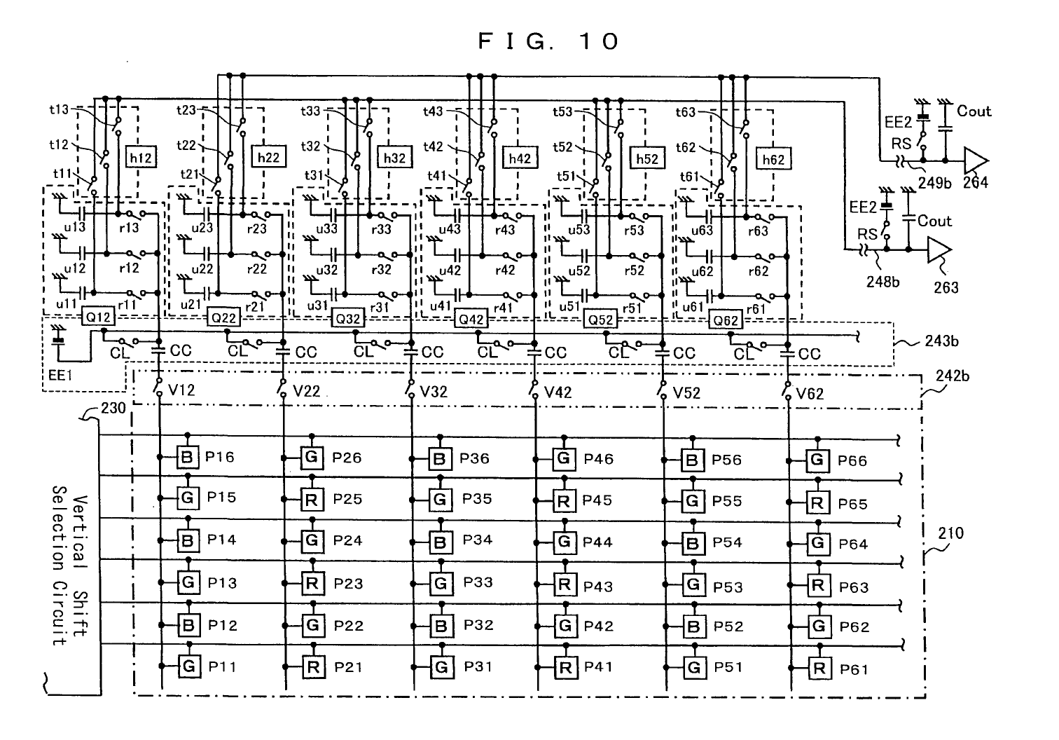

Action of the mixed-nine-pixel-reading-out mode will be described by referring to FIG. 9 and FIG. 10. FIG. 9 shows an enlarged view of the circuit configuration part for reading out the pixel data of the pixels on the first scanning line, and FIG. 10 is an enlarged view of the circuit configuration part for reading out the pixel data of the pixels on the second scanning line. The groups of pixels on the first to sixth lines of the photoelectrical conversion element array shown in FIG. 9 are also illustrated in FIG. 10.

The first line of the photoelectrical conversion element array 210 is selected by the vertical shift selection circuit 230. All the vertical transfer switches V11, V21, V31, V41, V51, V61—of the vertical transfer switch circuit 242a on the lower side are simultaneously closed and, further, all the first transmission switches e11, e21, e31, e41, e51, e61—in the signal voltage holding circuit 244a on the lower side are simultaneously closed so as to charge the voltage signals in the G (green) and R (red) pixels P11, P21, P31, P41, P51, P61—on the first line, respectively, to the first condensers d11, d21, d31, d41, d51, d62—of the signal voltage holding circuit 244a on the lower side. Then, all the clamp condensers CC are reset through ON-OFF operation of the clamp switch CL of the noise removing circuit 243a on the lower side.

At the same time, the second line of the photoelectrical conversion element array 210 is selected by the vertical shift selection circuit 230. All the vertical transfer switches V12, V22, V32, V42, V52, V62—of the vertical transfer switch circuit 242b on the upper side are simultaneously closed and, further, all the first transmission switches r11, r21, r31, r41, r51, r61—in the signal voltage holding circuit 244b on the upper side are simultaneously closed so as to charge the voltage signals in the B (blue) and G (green) pixels P12, P22, P32, P42, P52, P62—on the second line, respectively, to the first condensers u11, u21, u31, u41, u51, u61—of the signal voltage holding circuit 244b on the upper side. Then, all the clamp condensers CC are reset through ON-OFF operation of the clamp switch CL of the noise removing circuit 243b on the upper side.

Subsequently, after going through vertical shift by the vertical shift selection circuit 230 within a horizontal blanking period, reading-out is performed twice for selecting the third line. All the vertical transfer switches V11, V21, V31, V41, V51, V61—of the vertical transfer switch circuit 242a on the lower side are simultaneously closed and, further, all the second transmission switches e12, e22, e32, e42, e52, e62—in the signal voltage holding circuit 244a on the lower side are simultaneously closed so as to charge the voltage signals in the G (green) and R (red) pixels P13, P23, P33, P43, P53, P63—on the third line, respectively, to the second condensers d12, d22, d32, d42, d52, d62—of the signal voltage holding circuit 244a on the lower side. Then, all the clamp condensers CC are reset through ON-OFF operation of the clamp switch CL of the noise removing circuit 243a on the lower side.

At the same time, the fourth line of the photoelectrical conversion element array 210 is selected by the vertical shift selection circuit 230. All the vertical transfer switches V12, V22, V32, V42, V52, V62—of the vertical transfer switch circuit 242b on the upper side are simultaneously closed and, further, all the second transmission switches r12, r22, r32, r42, r52, r62—in the signal voltage holding circuit 244b on the upper side are simultaneously closed so as to charge the voltage signals in the B (blue) and G (green) pixels P14, P24, P34, P44, P54, P64—on the fourth line, respectively, to the second condensers u12, u22, u32, u42, u52, u62—of the signal voltage holding circuit 244b on the upper side. Then, all the clamp condensers CC are reset through ON-OFF operation of the clamp switch CL of the noise removing circuit 243b on the upper side.

Subsequently, after going through vertical shift in the vertical shift selection circuit 230 within a horizontal blanking period, reading-out is performed twice for selecting the fifth line. All the vertical transfer switches V11, V21, V31, V41, V51, V61—of the vertical transfer switch circuit 242a on the lower side are simultaneously closed and, further, all the third transmission switches e13, e23, e33, e43, e53, e63—in the signal voltage holding circuit 244a on the lower side are simultaneously closed so as to charge the voltage signals in the G (green) and R (red) pixels P15, P25, P35, P45, P55, P65—on the fifth line, respectively, to the third condensers d13, d23, d33, d43, d53, d63—of the signal voltage holding circuit 244a on the lower side. Then, all the clamp condensers CC are reset through ON-OFF operation of the clamp switch CL of the noise removing circuit 243a on the lower side.

At the same time, the sixth line of the photoelectrical conversion element array 210 is selected by the vertical shift selection circuit 230. All the vertical transfer switches V12, V22, V32, V42, V52, V62—of the vertical transfer switch circuit 242b on the upper side are simultaneously closed and, further, all the third transmission switches r13, r23, r33, r43, r53, r63—in the signal voltage holding circuit 244b on the upper side are simultaneously closed so as to charge the voltage signals in the B (blue) and G (green) pixels P16, P26, P36, P46, P56, P66—on the sixth line, respectively, to the third condensers u13, u23, u33, u43, u53, u63—of the signal voltage holding circuit 244b on the upper side. Then, all the clamp condensers CC are reset through ON-OFF operation of the clamp switch CL of the noise removing circuit 243b on the upper side.

When looking at the groups of pixels in the first to six rows of the first line, the third line and the fifth line, three pixel data of G (green) on the first row are held by the condensers d11, d12, d13, respectively, three pixel data of R (red) in the second row are held by the condensers d21, d22, d23, respectively, three pixel data of G (green) on the third row are held by the condensers d31, d32, d33, respectively, three pixel data of R (red) in the fourth row are held by the condensers d41, d42, d43, respectively, three pixel data of G (green) on the fifth row are held by the condensers d51, d52, d53, respectively, and three pixel data of R (red) in the sixth row are held by the condensers d61, d62, d63, respectively. The same relations are established in other rows as well.

The nine pixels in the first row, the third row and the fifth row of the first line, the third line and the fifth line are all G (green) pixels and the pixel data are held by the condensers d11, d12, d13, d31, d32, d33, d51, d52, d53. Thus, by simultaneously operating the nine horizontal transfer switches f11, f12, f13, f31, f32, f33, f51, f52, f53 corresponding to the condensers for charging the signal output condenser Cout of the first channel, the pixels data for the nine G (green) pixels are mixed. Then, the nine G (green) pixels mixed data is outputted from the first amplifier 261, which corresponds to the nine-G(green)-mixed pixel data D1 of the second output unit b1 in the first scanning unit as shown in FIG. 3.

Meanwhile, the nine pixels in the second row, the fourth row and the sixth row of the first line, the third line and the fifth line are all R (red) pixels and the pixel data are held by the condensers d21, d22, d23, d41, d42, d43, d61, d62, d63. Thus, at the same time as the reading-out of the nine G (green) pixels mixed data as described above, by simultaneously operating the nine horizontal transfer switches f21, f22, f23, f41, f42, f43, f61, f62, f63 corresponding to the condensers for charging the signal output condenser Cout of the second channel, the pixel data for the nine R (red) pixels are mixed. Then, the nine R (red) pixels mixed data is outputted from the second amplifier 262, which corresponds to the nine-R(red)-mixed pixel data D2 of the second output unit b1 in the first scanning unit as shown in FIG. 3.

Further, the nine pixels in the first row, the third row and the fifth row of the second line, the fourth line and the sixth line are all B (blue) pixels and the pixel data are held by the condensers u11, u12, u13, u31, u32, u33, u51, u52, u53. Thus, at the same time as the reading-out of each nine-pixels mixed data of G (green) and R (red) as described above, by simultaneously operating the nine horizontal transfer switches t11, t12, t13, t31, t32, t33, t51, t52, t53 corresponding to the condensers for charging the signal output condenser Cout of the third channel, the pixel data for the nine B (blue) pixels are mixed. Then, the nine-B(blue)-pixels mixed data is outputted from the third amplifier 263, which corresponds to the nine-B (blue)-mixed pixel data D3 of the second output unit b1 in the first scanning unit as shown in FIG. 3.

Meanwhile, the nine pixels in the second row, the fourth row and the sixth row of the second line, the fourth line and the sixth line are all G (green) pixels and the pixel data are held by the condensers u21, u22, u23, u41, u42, u43, u61, u62, u63. Thus, at the same time as the reading-out of each nine-pixels mixed data of G (green), R (red), and B (blue) as described above, by simultaneously operating the nine horizontal transfer switches t21, t22, t23, t41, t42, t43, t61, t62, t63 corresponding to the condensers for charging the signal output condenser Cout of the fourth channel, the pixel data for the nine G (green) pixels are mixed. Then, the nine-G(green)-pixels mixed data is outputted from the fourth amplifier 264, which corresponds to the nine-G (green)-mixed pixel data D4 of the second output unit b1 in the first scanning unit as shown in FIG. 3.

Thereby, separate and parallel output of the four pixel data of GRBG, in which nine pixels are mixed, respectively, by the second output unit b1 in the first scanning unit in FIG. 3 is performed simultaneously through four channels.

Subsequently, by shifting the second output unit as the output subject from b1 to b2 and repeating the same operation as described above, separate and parallel output of the four pixel data of GRBG, in which nine pixels are mixed, respectively, by the second output unit b2 in the first scanning unit in FIG. 3, is performed simultaneously through four channels.

After completing the simultaneous separate and parallel output of GRBG mixed data through the four channels, the selected scanning unit is shifted by one unit by the vertical shift selection circuit 230 and the same operation as described above is repeated. Thereby, the simultaneous separate and parallel output of GRBG mixed pixel data is performed through the four channels by the second output units b11, b12 composed of the groups of pixels in six lines and six rows as shown in GFIG. 3

As described above, virtual four-plate reading-out system of the simultaneous separate and parallel output of GRBG mixed pixel data through four channels is achieved, in which the mixed pixel data of each color is outputted from the output section of respective color and channel by the second output unit composed of the group of pixels in six lines and six rows. Further, it has a large number of pixels so that the optical cell size becomes large. As a result of multiplier effect, it is possible to record the highly fine moving pictures with a smooth movement with high pixels, so that the quality of the moving pictures can be remarkably improved compared to the related art.

For realizing the effect, it is achieved by simply applying a small contrivance to the output form of the pixel data in the control unit which reads out the pixel data from the photoelectrical conversion element array. Thus, complication of the structure can be avoided even though the quality of the moving picture is remarkably improved as described above. Therefore, advantageous effect can be expected in terms of manufacturing cost.

In the above-described embodiment, it is set to be n=3, however, it can be achieved by setting it to be n=4, n=5, n=6, etc. When set to be n=3, (2n)²=6²=36=4×9, so that the pixels of GRBF are mixed by nine pixels each with the group of pixels in six lines and six rows being the second output unit.

When set to be n=4, (2n)²=8²=64=4×16, so that the pixels of GRBF may be mixed by sixteen pixels each with the group of pixels in eight lines and eight rows being the second output unit. In this case, 5,120 pixels in horizontal direction×3,840 pixels in the vertical direction are approximately 19,700,000 pixels. Thus, with a unit being the pixels in eight lines and eight rows, it becomes VGA in the virtual four-plate reading out system.

Furthermore, when set to be n=5, (2n)²=10²=100=4×25, so that the pixels of GRBF may be mixed by twenty-five pixels each with the group of pixels in ten lines and ten rows being the second output unit. In this case, 6,400 pixels in horizontal direction×4,800 pixels in the vertical direction are approximately 30,700,000 pixels. Thus, with a unit being the pixels in ten lines and ten rows, it becomes VGA in the virtual four-plate reading out system.

Moreover, when set to be n=6, (2n)²=12²=144=4×36, so that the pixels of GRBF may be mixed by thirty-six pixels each with the group of pixels in twelve lines and twelve rows being the second output unit. It also becomes the above-described virtual four-plate reading-out system in the same manner.

While the invention has been described and illustrated in detail, it is to be clearly understood that this is intended be way of illustration and example only and is not to be taken by way of limitation, the spirit and scope of this invention being limited only be the terms of the following claims.

1. A color solid state image pickup device, comprising a photoelectrical conversion element array and a control unit for controlling reading-out of pixel data generated by said photoelectrical conversion element array, wherein:
said photoelectrical conversion element array comprises a plurality of photoelectrical conversion elements (pixels) arranged in matrix and generates pixel data of four colors with a group of pixels in two lines and two rows being a unit; and
said control unit comprises four channels of output sections, reads out the pixel data from said photoelectrical conversion element array, and outputs the read-out pixel data from said four channels by switching a whole-pixel-reading-out mode and a mixed-pixel-reading-out mode, wherein:
said whole-pixel-reading-out mode is a mode for picking up still pictures, which outputs pixel data of the whole pixels by scanning an output form by a first output unit, said output form performing, simultaneously, output of pixel data of a first color from a first output section, output of pixel data of a second color from a second output section, output of pixel data of a third color from a third output section, output of pixel data of a fourth color from a fourth output section through four channels of output sections with the group of pixels in two lines and two rows in said photoelectrical conversion element array being said first output unit; and
said mixed-pixel-reading-out mode is a mode for recording moving pictures, which outputs pixel data after reducing the number of pixels by scanning an output form by a second output unit, said output form performing, simultaneously, output of mixed pixel data of a first color from a first output section, output of mixed pixel data of a second color from a second output section, output of mixed pixel data of a third color from a third output section, output of mixed pixel data of a fourth color from a fourth output section through four channels of output sections after n×n numbers of pixel data of the same color in second output unit are mixed by each color with the group of pixels in 2n lines and 2n rows being said second output unit, with n being any natural number.

2. The color solid state image pickup device according to claim 1, wherein, among said four pixel data in said photoelectrical conversion element array, two pixel data are in the same color.

3. The color solid state image pickup device according to claim 1, wherein said four pixel data in said photoelectrical conversion element array are pixel data arranged in Bayer pattern.

4. The color solid state image pickup device according to claim 1, wherein said four pixel data in the photoelectrical conversion element array are pixel data in respective complementary colors of cyanogens, magenta, yellow and green.

5. The color solid state image pickup device according to claim 1, wherein said photoelectrical conversion element array comprises:
a photodiode;
a cell amplifier; and
a color filter.

6. The color solid state image pickup device according to claim 1, wherein said control unit: in said mixed-pixel-reading-out mode, performs scanning by an output unit which is a group of pixels in six lines and six rows in said photoelectrical conversion element array; and
in said mixed-pixel-reading-out mode, operates by a mixed-nine-pixel unit.

7. The color solid state image pickup device according to claim 1, wherein said control unit comprises:
a vertical transfer switch circuit for two lines for reading out pixel data from said photoelectrical conversion element array;
a signal voltage holding circuit for two lines for temporarily holding the read-out data;
a horizontal transfer switch circuit for two lines for outputting pixel data or mixed pixel data from said signal voltage holding circuit by dividing the data to two channels each;
a horizontal shift selection circuit for switching output by said whole-pixel-reading-out mode and output by mixed-pixel-reading-out mode through controlling said horizontal transfer switch circuit; and
an output amplifier with four channels for outputting, from said horizontal shift selection circuit, a total of four pixel data or mixed-pixel data separately and in parallel with respect to each other.
